(19) United States
(12) Patent Application Publication
(10) Pub. No.: US 2006/0184372 A1
(43) Pub. Date: Aug. 17, 2006

(54) Intelligence value index calculation method

(75) Inventors: Ellie Okada, Tokyo (JP); Yutaka Inoue, Tokyo (JP); Yoshiaki Ishikawa, Tokyo (JP)

Correspondence Address: BURR & BROWN, PO BOX 7068, SYRACUSE, NY, 13261-7068, US

(73) Assignee: Ellie Okada, Minato-ku (JP)

(21) Appl. No.: 10/551,560

(22) PCT Filed: Apr. 5, 2004
(86) PCT No.: PCT/JP04/04907

§ 371 Date: Oct. 3, 2005

(30) Foreign Application Priority Data
Apr. 4, 2003 (JP) 2003-101887

(51) Int. Cl. G06Q 99/00

(52) U.S. Cl. 705/1

(57) ABSTRACT

It is possible to judge an enterprise value which does not appear in finance tables. For each of the enterprises stored in a database, the technical innovation power of the enterprise, relationship with a customer and a business partner, productivity of employees, usefulness of the facility, benefit brought about in future by intellectual activity, and market viewpoint are calculated as standardized data which is standardized by the average value and standard deviation for each of classified jobs. The standardized data is, all at once, subjected to a main component analysis processing based on a variance-covariance matrix and each factor is weighted. For each enterprise, each factor is multiplied by the weight and added, thereby calculating the intellectual potentiality.

### TECHNICAL FIELD

The present invention relates to an effective technique employed for determination of a value of an enterprise using an information processing apparatus.

### BACKGROUND ART

In recent years, when an attempt is made to measure a certain enterprise value for the purpose of investment target analysis or the like, only financial statements such as a profit and loss statement and a balance sheet and stock related indexes are not enough any more.

For example, requests are made to evaluate an enterprise comprehensively taking into account “invisible” values such as technologies and know-how that are not reflected on the financial statements.

In Japanese Patent Application No. 2002-031002, the applicant of the present invention discloses a technique for measuring “awareness”, “royalty”, and the like of stakeholders such as customers, employees, and shareholders and calculating a present value of a cash flow that will be generated by a brand in future.

As a literature of this type, there is known an article entitled “Adjusted PBR” written by Mr. Takaaki Yoshino in “Weekly Toyo Keizai” issued Mar. 18, 2003 (“Weekly Toyo Keizai, Takaaki Yoshino, ‘Adjusted PBR’” Toyo Keizai Inc., Mar. 18, 2003).

Both the related arts are excellent in that an enterprise value not reflected on the financial statements is judged. However, the inventors have found that, in order to allow investors to judge an enterprise as an investment target, a trial calculation of an enterprise value that can be generated when the enterprise uses all intellectual potentialities (=an estimated aggregate market value) should be made to compare the estimated aggregate market value with an actual market value in the stock market.

In this respect, in all the conventional methods of evaluating potentialities of an enterprise, qualitative evaluations such as a questionnaire targeting journalists and analysts are often performed. Thus, it is still likely that arbitrary judgment of evaluators is added to the evaluation indirectly by limiting targets of the questionnaire.

The invention has been devised in view of such points and it is an object of the invention to provide an index for measuring potentialities of an enterprise, which combines a research and development ability and a technical innovation ability of the enterprise with an enterprise value, through practice of intellectual management, that is, an “intelligence value index” (“intelligence value index” in Japanese is a trademark of Nihon Keizai Shinbun Inc.).

### DISCLOSURE OF THE INVENTION

The invention calculates standardized data obtained by standardizing, for each of categories of business classified in advance, a technical innovation ability, relationship with customers and clients, productivity of employees, usability of facilities, expected future returns to be generated by intellectual activities, and a market viewpoint of each of enterprises stored in a database according to average values and standard deviations of the factors, subjects the standardized data to principal component analysis processing based on a variance covariance matrix collectively to perform weighting of the respective factors, and calculates a numerical value, which is obtained by multiplying the respective factors by weights and adding up the factors for each of the enterprises, as intellectual potentialities. Moreover, the invention estimates a potential enterprise value from the viewpoint of intelligence by performing a multiple regression analysis using the same data with a market viewpoint set as an explained variable and the other variables set as explanatory variables.

According to the invention, it is possible to calculate intellectual potentialities with high transparency and objectivity, that is, an intelligence value of an enterprise on the basis of available financial data. Moreover, it is possible to derive an intrinsic value of an enterprise from an intelligence viewpoint as an estimated enterprise value and compare the estimated enterprise value with a market value in an actual stock market.

The enterprise value evaluation is an evaluation method with high improvability because a model formula has to be changed according to patent properties and the like to be laid open anew in future. However, according to the invention, it is possible to realize an improved enterprise evaluation method.

Since international accounting tends to disclose “intangible assets” not reflected on the financial statements, the present invention can realize such a highly advanced enterprise evaluation method.

According to the invention, an enterprise can obtain an enterprise evaluation index with high transparency and objectivity on the basis of a research and development ability and available financial data thereof by using objective data obtained from financial reports.

According to the invention, it is also possible to change a model formula according to patent properties and the like to be disclosed anew in future. Thus, it is possible to realize an evaluation method with high improvability.

### BRIEF DESCRIPTION OF THE DRAWINGS

FIG. 1 is a diagram for explaining a data structure of a server in an embodiment of the invention;

FIG. 2 is a diagram of evaluation factor data for respective industries;

FIG. 3 is a block diagram showing a calculation procedure for an intellectual potential index and a calculation procedure for an estimated enterprise value;

FIG. 4 is a diagram for explaining a specific example corresponding to FIG. 1;

FIG. 5 is a block diagram of a procedure corresponding to FIG. 3;

FIG. 6 is a block diagram showing a relation between calculation of an “intellectual potential index” using evaluation factors in the embodiment and calculation of an “estimated enterprise value”;

FIG. 7 is an example of back data for intellectual value ranking stored in a server 1 in the embodiment;

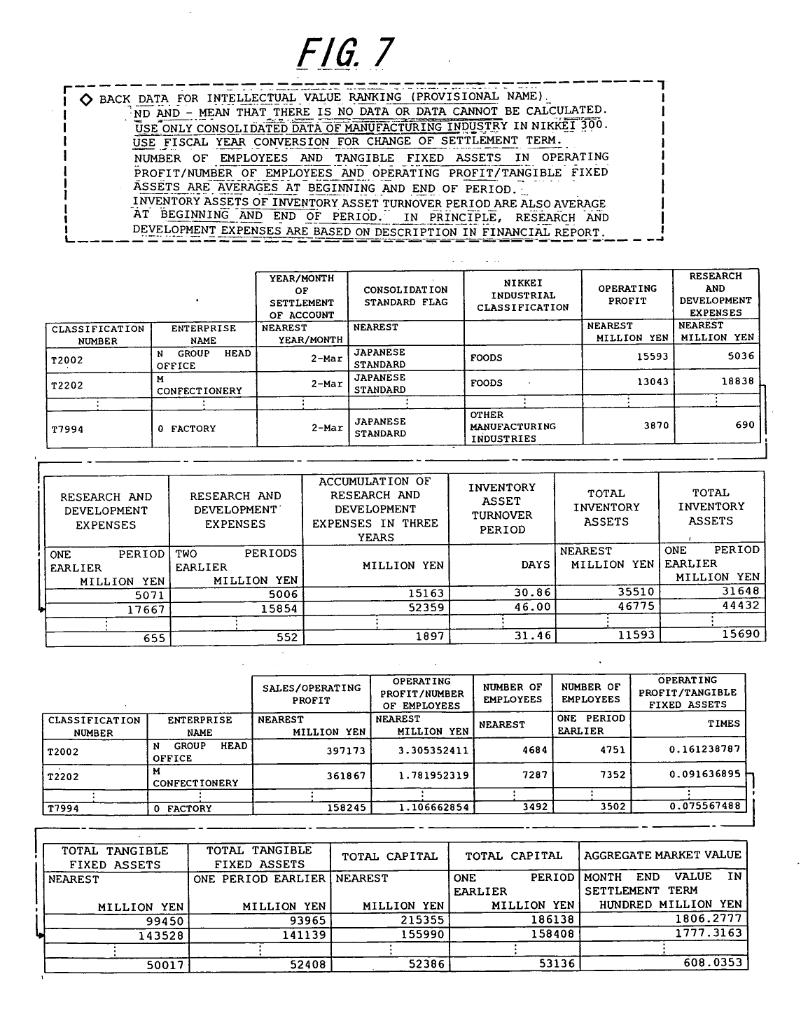

FIG. 8 is an example of data of evaluation factors in an industry 1, the textile and ceramic industry, stored in a server 2 in the embodiment;

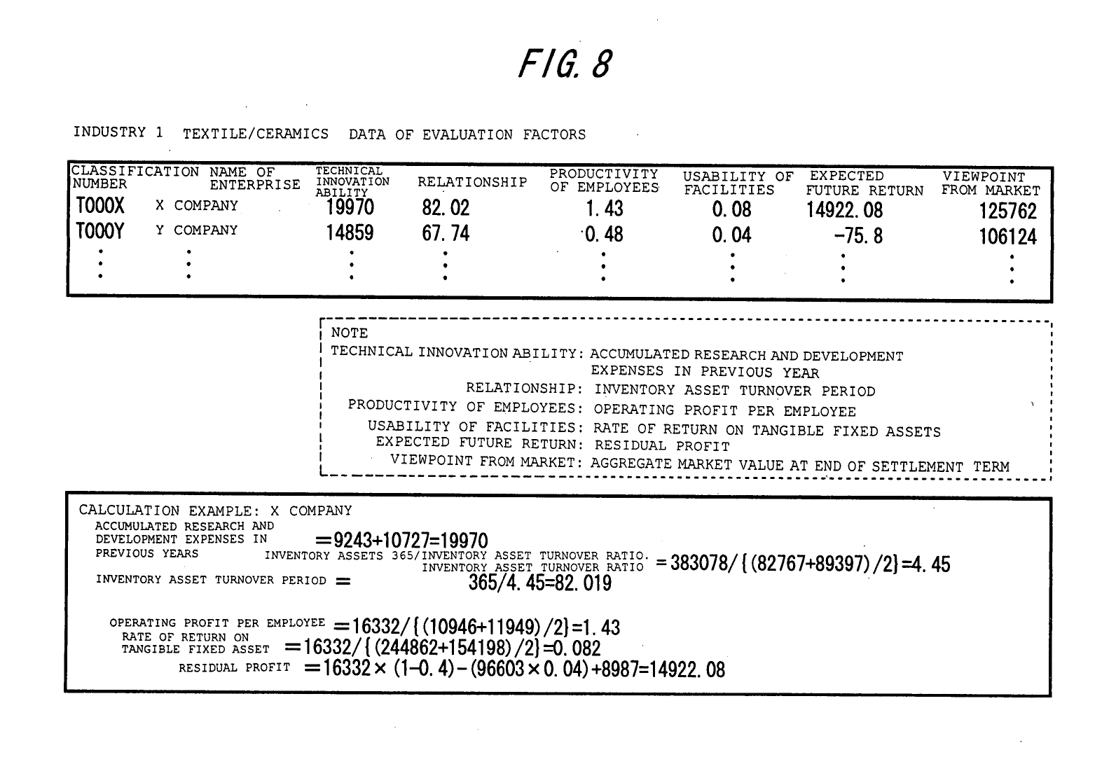

FIG. 9 is a data processing procedure (1) for calculating an “intellectual potential index” in the embodiment;

FIG. 10 is a data processing procedure (2) for calculating an “intellectual potential index” in the embodiment;

FIG. 11 is a data processing procedure (3) for calculating an “intellectual potential index” in the embodiment;

FIG. 12 is a data processing procedure (1) for calculating an “estimated enterprise value” in the embodiment;

FIG. 13 is a data processing procedure (2) for calculating an “estimated enterprise value” in the embodiment;

FIG. 14 is a data processing procedure (3) for calculating an “estimated enterprise value” in the embodiment;

FIG. 15 is an example of calculation of standardized data of respective evaluation factors for T Company in the pharmaceutical industry;

FIG. 16 is an example of calculation of an intellectual potential index for T Company in the pharmaceutical industry; and

FIG. 17 is an example of calculation of an estimated enterprise value for T Company in the pharmaceutical industry.

### BEST MODE FOR CARRYING OUT THE INVENTION

An embodiment of the invention will be hereinafter explained with reference to the drawings.

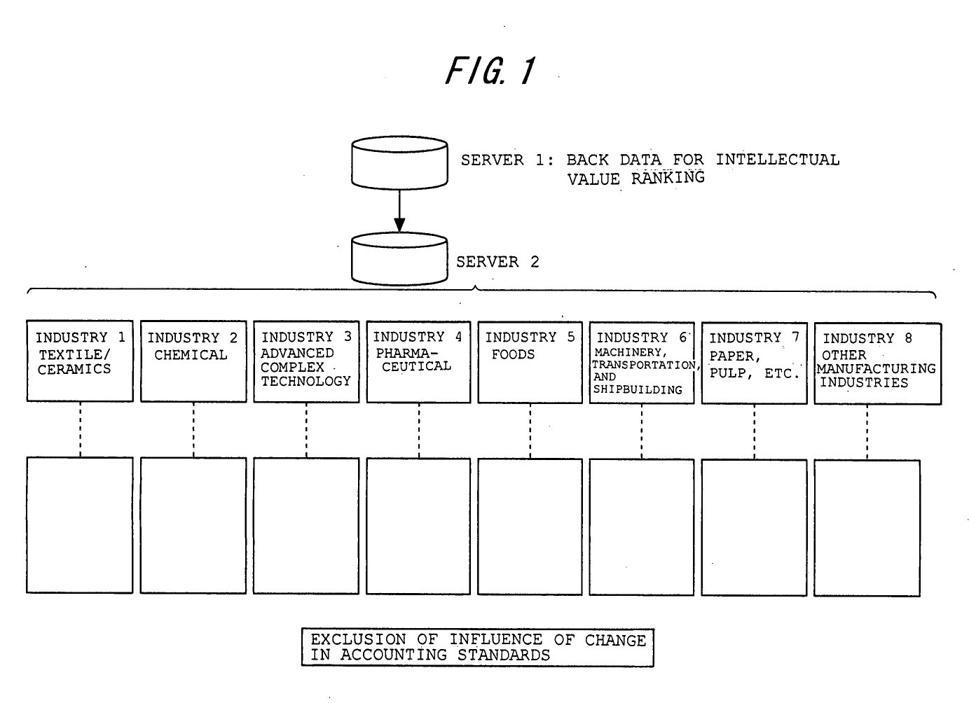

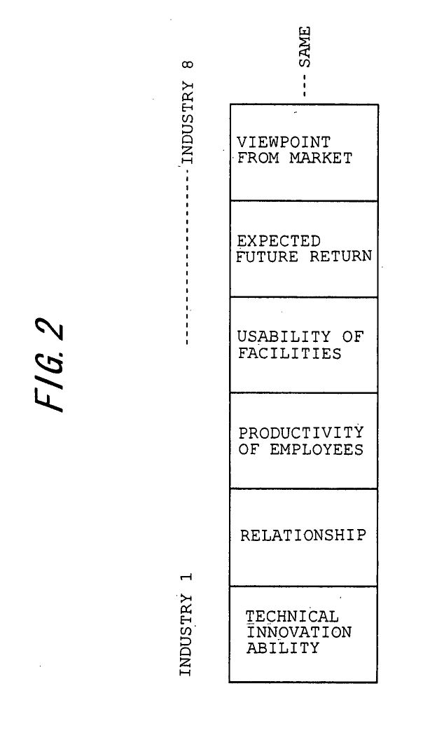

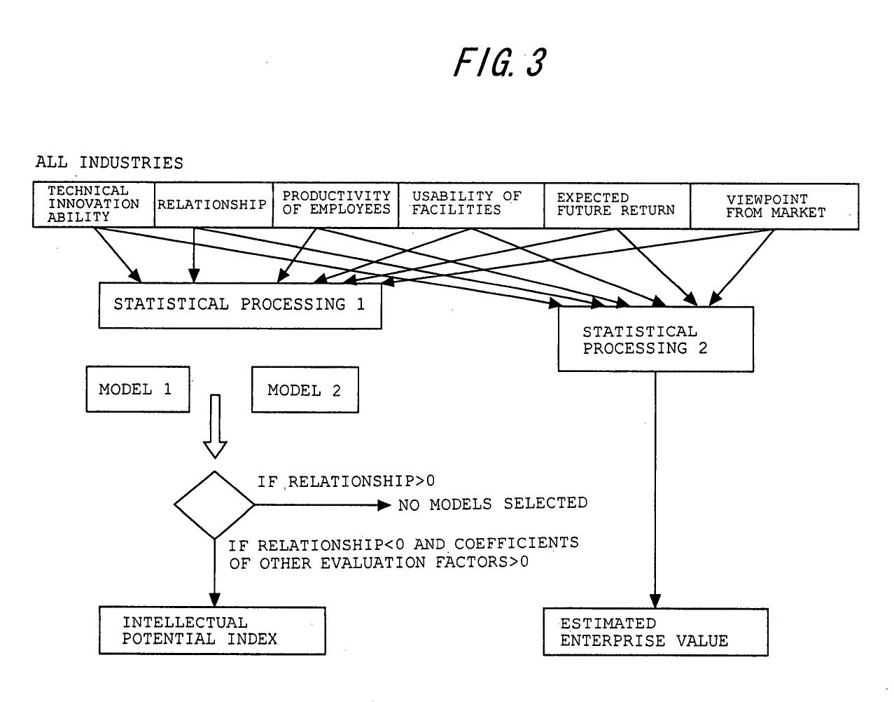

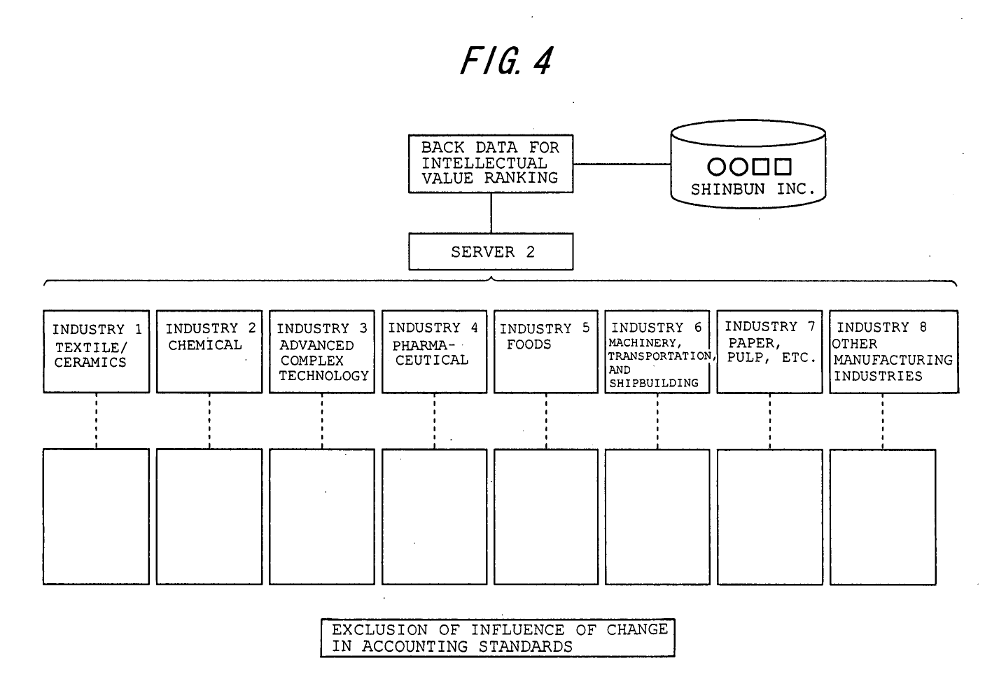

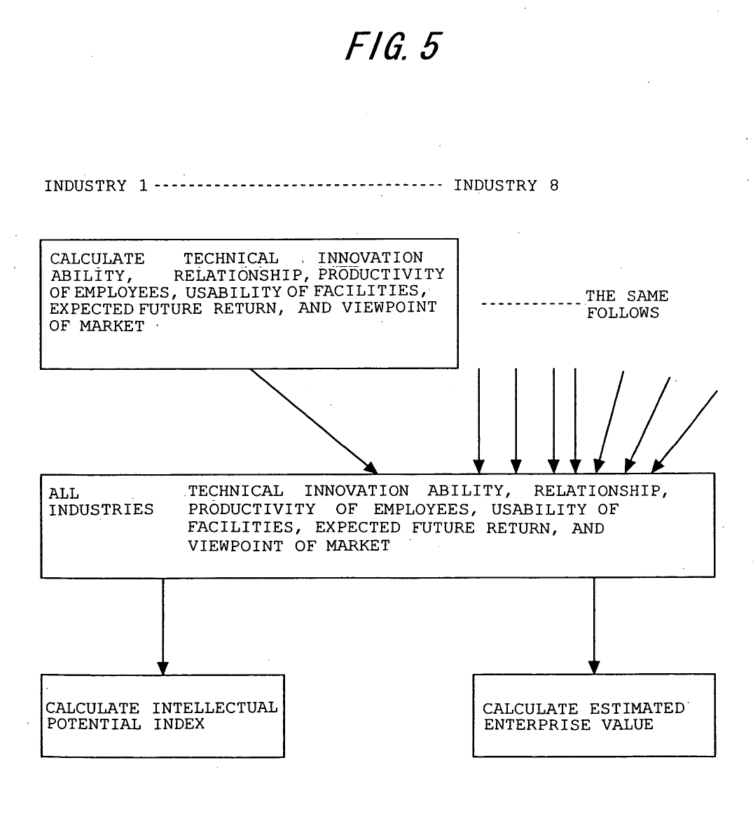

FIG. 1 is a diagram for explaining a data structure of a server in this embodiment. FIG. 2 is a diagram of evaluation factor data for respective industries. FIG. 3 is a block diagram showing a calculation procedure for an intellectual potential index and a calculation procedure for an estimated enterprise value. FIG. 4 is a specific example corresponding to FIG. 1. FIG. 5 is a block diagram of a procedure corresponding to FIG. 3.

In this embodiment, six factors, namely, 1) a technical innovation ability of an enterprise, 2) establishment of relationship with customers and clients, 3) process improvement, 4) intellectual activities of an enterprise such as effective utilization of facilities, 5) expected future returns to be generated by intellectual activities, and 6) market viewpoint, were selected as evaluation factors. Unobservable factors underlying these factors were extracted and assumed as intellectual potentials.

Specifically, accumulation in the past two years of investments in research and development, which was the motive power of technical innovation of an enterprise was selected as 1) the “technical innovation ability”, a stock turnover period indicating establishment and efficiency of relationship with customers and clients was selected as 2) the “relationship”, improvement of productivity of employees based on improvement of a process of employees was selected as 3) the “productivity of employees”, improvement of facility efficiency based on effective design and utilization of facilities was selected as 4) the “usability of facilities”, a residual profit (an operating profit after deduction of capital cost and taxes and nearest investments in research and development) in the next period was selected as 5) the “expected future return”, and an aggregate market value in a nearest settlement term end was selected as 6) the “market point of view”. New indexes were calculated by extracting unobservable and invisible axes on the common basis of these factors according to a principal component analysis by the variance covariance matrix.

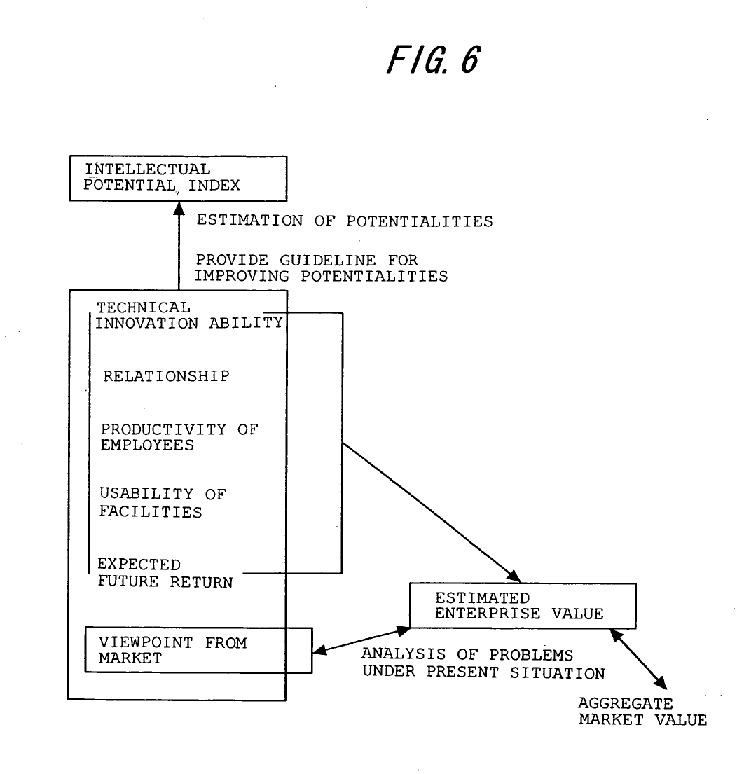

Note that FIG. 6 is a block diagram showing a relation between calculation of an “intellectual potential index” using these evaluation factors and calculation of an “estimated enterprise value”.

In this embodiment, details of evaluation factors and data used are explained as follows:

1) Technical innovation ability (an accumulation of investments in research and development in the past two periods);

2) Relationship (a stock turnover period: 365/(sales/average stock on hand in the previous period and the current period));

3) Productivity of employees (operating profit/average number of employees in the previous period and the current period);

4) Usability of facilities (operating profit/average tangible fixed assets in the previous period and the current period);

5) Expected future return (according to the random walk model, assuming that a residual profit in the next period is equal to a residual profit in the current period, a residual profit is calculated by adding investments in research and development in the current period to an operating profit after deduction of taxes and capital cost); and

6) Market point of view (an aggregate market value at the nearest settlement term end).

Among these evaluation factors, only the factor representing the “relationship” has a characteristic that, as a value of the factor is smaller, a larger future return is produced. Concerning a significant principal component, a principal component score coefficient should be minus for this evaluation factor.

This evaluation factor has an effect of making, when selecting one of plural principal components derived by a principal component analysis, the selection mechanical and easy. In addition, as described later, the aggregate market value used in the “market point of view” has an effect of controlling an effect caused by the difference in enterprise scale.

Note that the ratio of investments in research and development to an operating profit is not used as an index because the effect of using this ratio as an index prevents enterprises, which make practical use of development results of other companies in order to acquire profits efficiently, from having an advantage and prevents enterprises active in basic researches from being eliminated.

Also note that unlimited investments in research and development are prevented from leading to a high score by a calculation structure for this index which is used for calculating a common axis of the investments in research and development, the expected future return/the viewpoint of the market, and the other evaluation factors.

The point of judging the improvement of a process according to the productivity of employees is to judge the ability of individual employees to generate profits in a main business. Moreover, the point of judging the effective utilization of facilities according to the index using the operating profit is to give advantage to enterprises that strictly apply asset impairment accounting. This is because impairment caused by applying assets impairment accounting is included in non-operating expenditure.

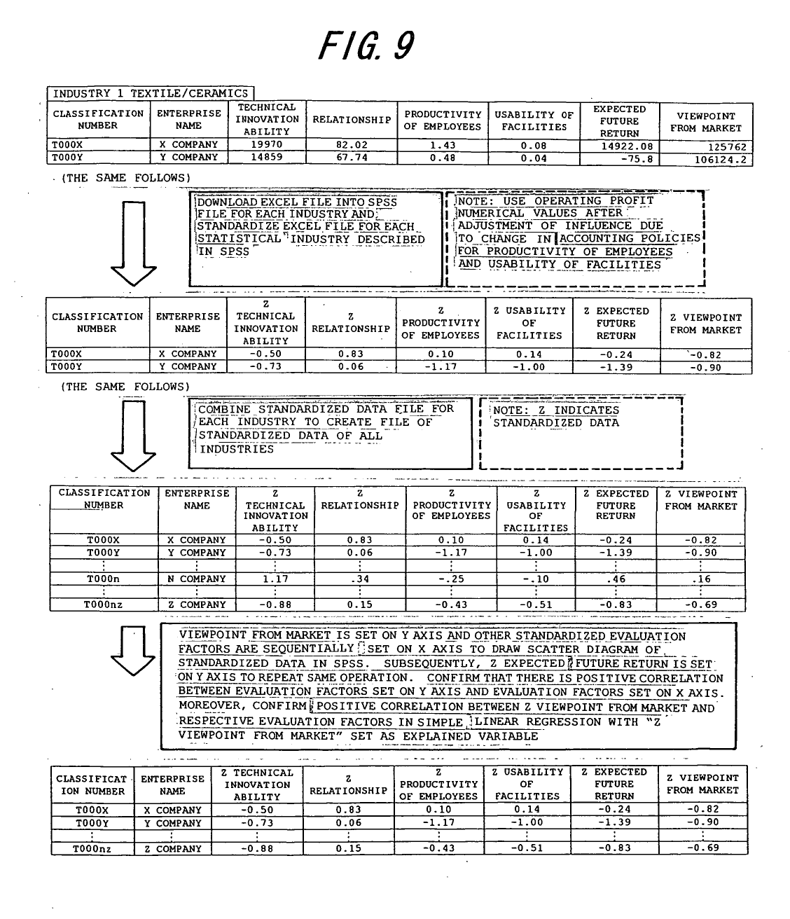

A procedure of data processing for calculating the “intellectual potential index” will be hereinafter explained using FIGS. 9 to 11.

As shown in FIG. 4, data used is consolidated accounting data prepared by NEEDS-COMPANY (the comprehensive enterprise data bank system of Nihon Keizai Shinbun Inc.). Note that the subjects of the study are manufacturing enterprises. However, the range of the subjects may be expanded to include non-manufacturing enterprises.

Prior to calculating an intellectual potential index, it is necessary to determine the effects exerted by the category of the business activity, the technical characteristic, and the enterprise scale. For that purpose, the subject enterprises are classified according to category-of-business activity based on the NEEDS-COMPANY concept. Then, categories of business having similar technical characteristics are classified as single category of business to determine the effects exerted by the category of business and the technology.

Specifically, the textile industry and the ceramic industry judged according to material technology were integrated as one business category; the automobile industry judged according to fuel cell, the electric industry, and the precision equipment industry judged according to complex information technology were integrated as a complex advanced technology; the machinery industry, the transportation equipment industry, and the shipbuilding industry were integrated; and the paper industry, the pulp industry, the petroleum industry, the rubber industry, the steel industry, and the nonferrous metal industry mainly providing raw materials were integrated.

Further, it is possible to control the difference in enterprise scale according to an aggregate market value used as the market point of view. In other words, this evaluation factor is also given an effect of controlling the scale difference of each category of business while reflecting a difference of market evaluation in the same category of business. Therefore, the industrial classifications is as follows:

Industry 1) textile and ceramics;

Industry 2) chemical;

Industry 3) advanced complex technology;

Industry 4) pharmaceutical;

Industry 5) foods;

Industry 6) machinery, transportation, and shipbuilding

Industry 7) paper, pulp, etc.; and

Industry 8) other manufacturing industries.

As shown in FIG. 9, operating profit data is used for the productivity of employees and the usability of facilities as data representing evaluation factors.

In order to eliminate effects caused by changes made to the accounting policy of an enterprise, on the operating profit, enterprises changing their accounting policies were checked against a database. Therefore, for the enterprise that has changed its accounting policies, a monetary amount of the effect of the change made to the operating profit disclosed in a brief memorandum of the most recent financial statement following the end of the fiscal year was investigated. An amount of an operating profit before the change was calculated. Using a ratio of an operating profit after the change and an operating profit before the change, magnitudes of indexes representing the productivity of employees and the usability of facilities were adjusted to magnitudes when data before the change was used.

Note that the operating profit data is also used for the residual profit serving as the expected profit in future. However, this residual profit is a residual profit in future. Since it is assumed that an operating profit in the next period is equal to an operating profit based on the accounting policies after the change, an operating profit when calculating the residual profit is not adjusted.

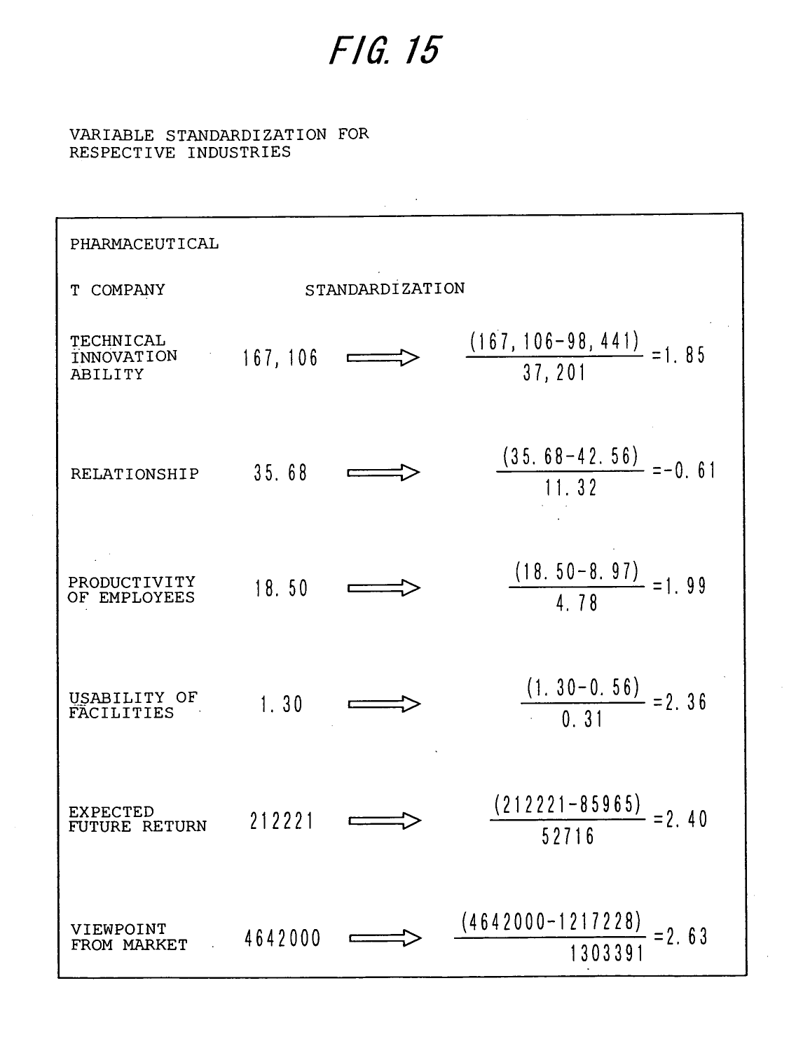

Subsequently, data based on the selected six evaluation factors was standardized according to an average value and a standard deviation thereof for each category of business classified anew. Specifically, data presented in a table format was downloaded into an SPSS file and standardized for each statistical industry described in the SPSS. The industry data (the standardized data) corresponds to the data shown in FIG. 2. FIG. 15 is an example showing an example for calculating standardized data of respective evaluation factors for T Company in the pharmaceutical industry.

The SPSS is data analysis application software for supporting statistical analysis. The SPSS has a characteristic for facilitating complicated analyses such as a multiple regression analysis, a principal component analysis, a discrimination analysis, and a multidimensional scaling.

A single file of standardized data for all the industries is generated by joining the standardized data files related to each industry.

Subsequently, a scatter diagram among respective variables was referenced in order to confirm appropriateness of selected evaluation factors for the standardized data. A simple linear regression analysis, between the residual profit, the aggregate market value data and the other respective data, and between the residual profit data and the aggregate market value data was also carried out to confirm a relation among the data.

Specifically, a market point of view Z was set on the Y axis and other standardized evaluation factors were sequentially set on the X axis to repeat the same operation. It was confirmed that the evaluation factor set on the Y axis and the evaluation factors set on the X axis have a positive correlation. A positive correlation between the market point of view Z and the respective evaluation factor was confirmed in simple linear regression with an explained variable set as the “market point of view Z”.

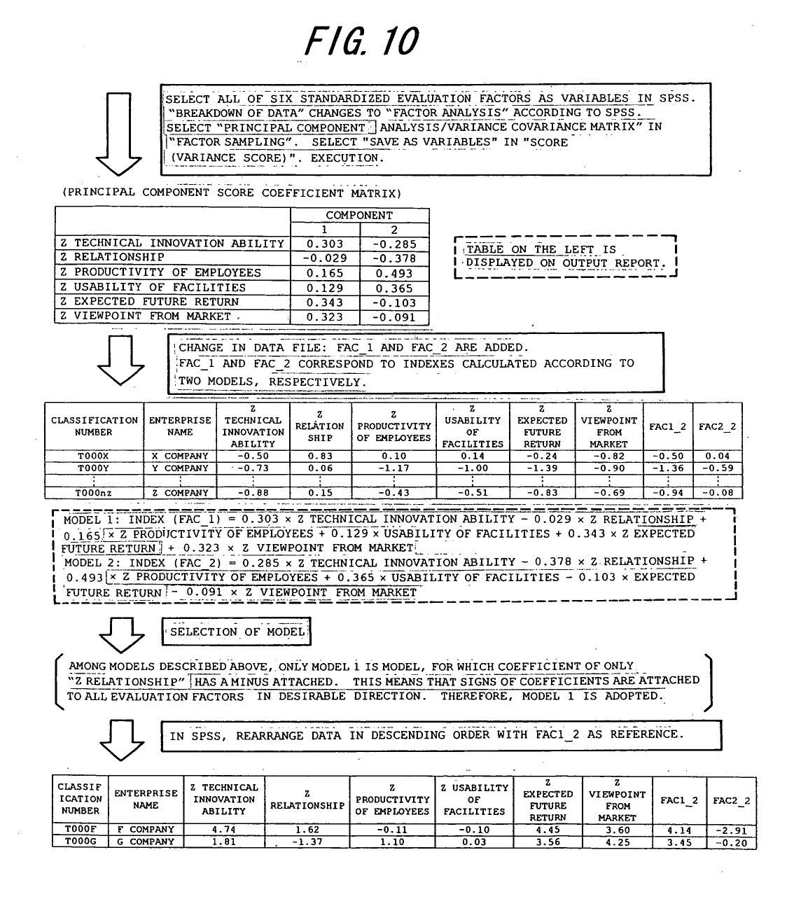

As shown in FIG. 10, it is confirmed that the sum of squares of loading after applying a principal component analysis based on the variance covariance matrix to the standardized data collectively and extracting principal components exceeds 70%. Then, signs of the derived principal components are checked. Focusing on to the “relationship” that is the only factor, which clearly produces a smaller merit as a value thereof is smaller, among the evaluation factors, a principal component, for which a sign of the “relationship” is a minus, is selected. When data of a settlement account in 2001 is used, two principal components are derived. A principal component, for which the “relationship” factor is minus, among the principal components is derived uniquely. Note that weights for the evaluation factors was 0.303 for the technical innovation ability, −0.029 for the relationship, 0.265 for the productivity of employees, 0.129 for the usability of facilities, 0.343 for the expected future return, and 0.323 for the view from the market. In other words, the following expression is established.
Intellectual potential index=0.303×technical innovation ability−0.029×relationship+productivity of employees+0.129×usability of facilities+0.343×expected future return+0.323×market point of view

The “intellectual potential” index was found in principal component scores derived resultantly. Ranking was made in an order of magnitudes of the principal component scores. In general, when standardized data was directly used as an index, it was hard to understand the index. Thus, after changing the indexes to standard deviations, an axis was translated to set a highest point at 100. This is a score of the “intellectual potential” index on which the ranking is based.

In FIG. 10, a model 1 (index (FAC_1)) and a model 2 (index (FAC_2)) are added. These models correspond to the indexes calculated according to the two models, respectively.

A model, for which a coefficient of only “Z relationship” is minus, is the model 1. This means that, for the model 1, signs of coefficients are attached to all the evaluation factors in a desirable direction. Therefore, the model 1 is adopted.

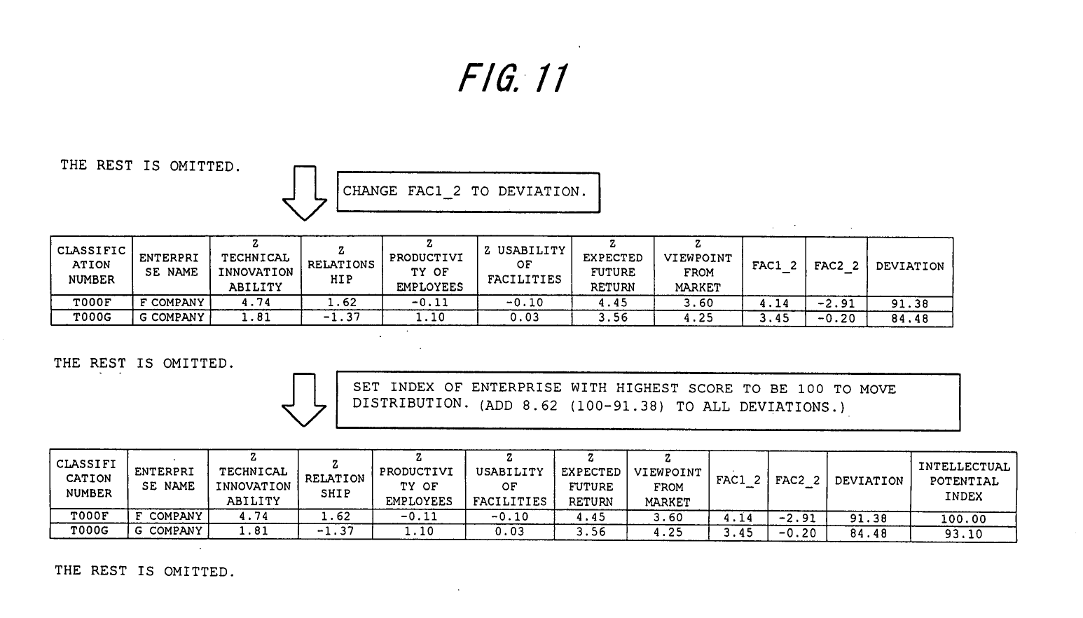

In this way, the data are rearranged in a descending order with FAC1_2 as a reference in SPSS as shown in a table at the bottom of FIG. 10. The FAC1_2 is changed to deviations as shown in FIG. 11 and an index of an enterprise with the highest score is set to be 100 in order to move a distribution. Since a deviation highest value of F Company is 91.38, 8.62 (100−9.38) is added to the deviations of all the enterprises. As a result, an intellectual potential index of N Company is 100.00 and an intellectual potential index of G Company is 93.10.

This index (the intellectual potential) does not only simply show a magnitude of potential, but also by using an industry average and standardized data in standard deviations, the index shows a positioning in an industry according to the standardized data constituting the index and provides a guideline for improving future potentials.

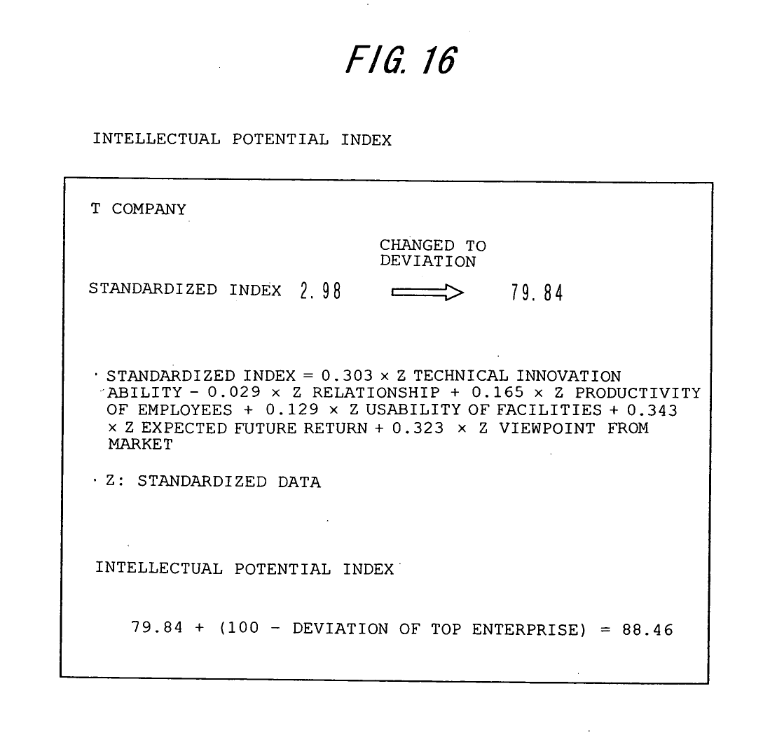

FIG. 16 shows a specific example in which an intellectual potential index is calculated for T Company mentioned earlier.

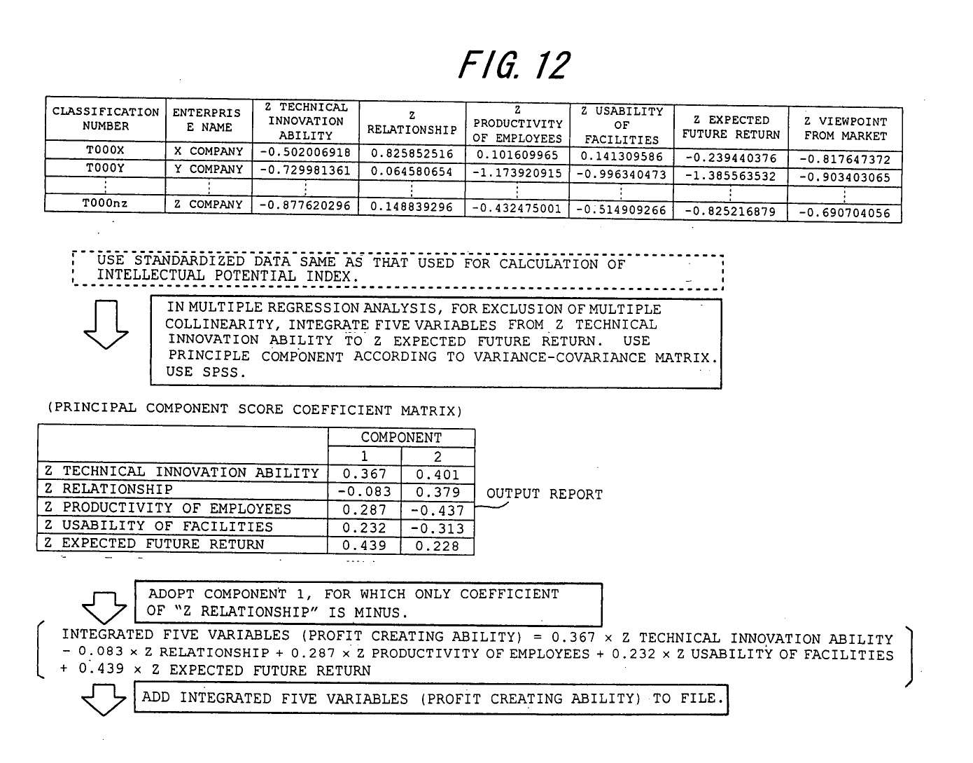

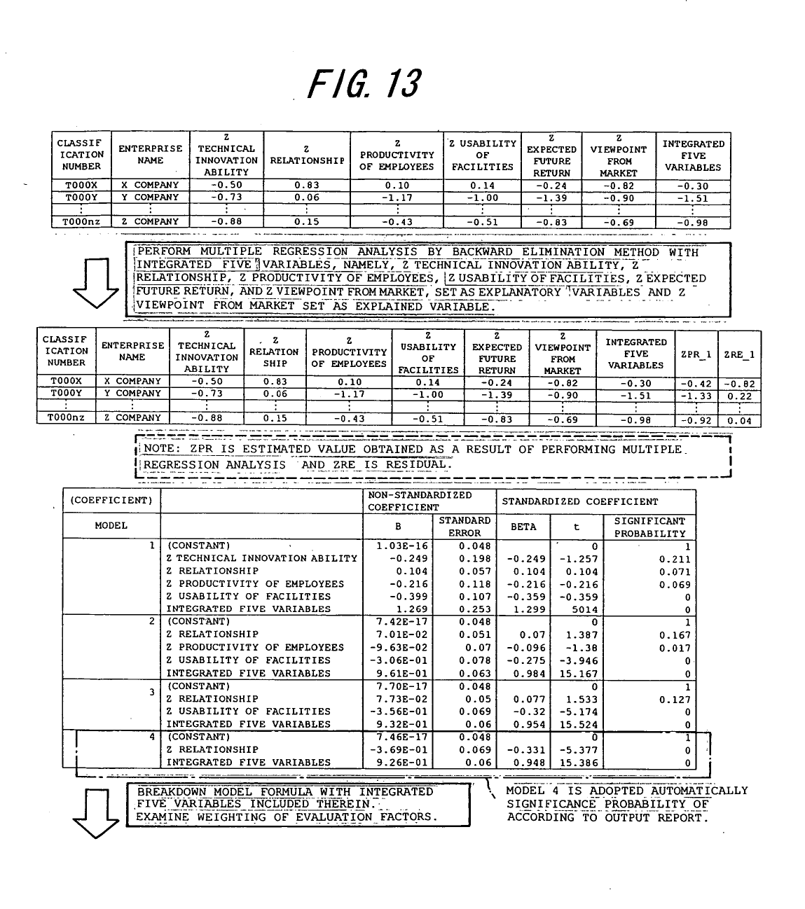

A procedure for calculating an estimated enterprise value using standardized data which is the same as that adopted in the procedure described above will be explained using FIGS. 12 to 14.

This means an enterprise value estimated from an intelligence viewpoint. Whereas the intellectual potential contributes to estimation of potential for developing future “intelligence”, the estimated enterprise value also has an effect in a present situation analysis. The estimated enterprise value uses an aggregate market value at the time of a settlement of account as an explained variable and derives the aggregate market value by performing the multiple regression analysis with data based on the other evaluation factors as explanatory variables.

It is possible to confirm a gap between an actual aggregate market value and an estimated enterprise value estimated from the viewpoint of “intelligence” and observe whether intellectual activities of an enterprise is connected to an enterprise value that is being actually developed.

Note that an enterprise having an actual result of an aggregate market value higher than an estimated value is not always overvalued. The enterprise sometimes performs creation of values that exceeds an overall tendency of intellectual activities of enterprises. In an opposite case, an enterprise is not always undervalued but has some problems in its enterprise activities. Evaluation of an enterprise should be judged based on the aggregate market value as well as on the intellectual potential index.

Specifically, as shown in FIG. 12, standardized data same as that used for the calculation of an intellectual potential index is used.

In order to eliminate multiple collinearity of data, after confirming a variable selected according to a multiple regression analysis by a backward elimination method and recognizing evaluation factors in a multiple collinear relation, variables in the multiple collinear relation are integrated according to the principal component analysis.

Specifically, the five variables excluding the “market point of view” are integrated according to the principal component analysis.

Multiple regression using the integrated variable and all the variables which are not integrated as explanatory variables and the aggregate market value as an explained variable was carried out. A regression coefficient of the integrated variable was multiplied by respective principal component score coefficients at the time of integration to derive regression coefficients of the respective variables forming bases of the integrated variables and calculate a standardized estimated enterprise value (FIG. 12).

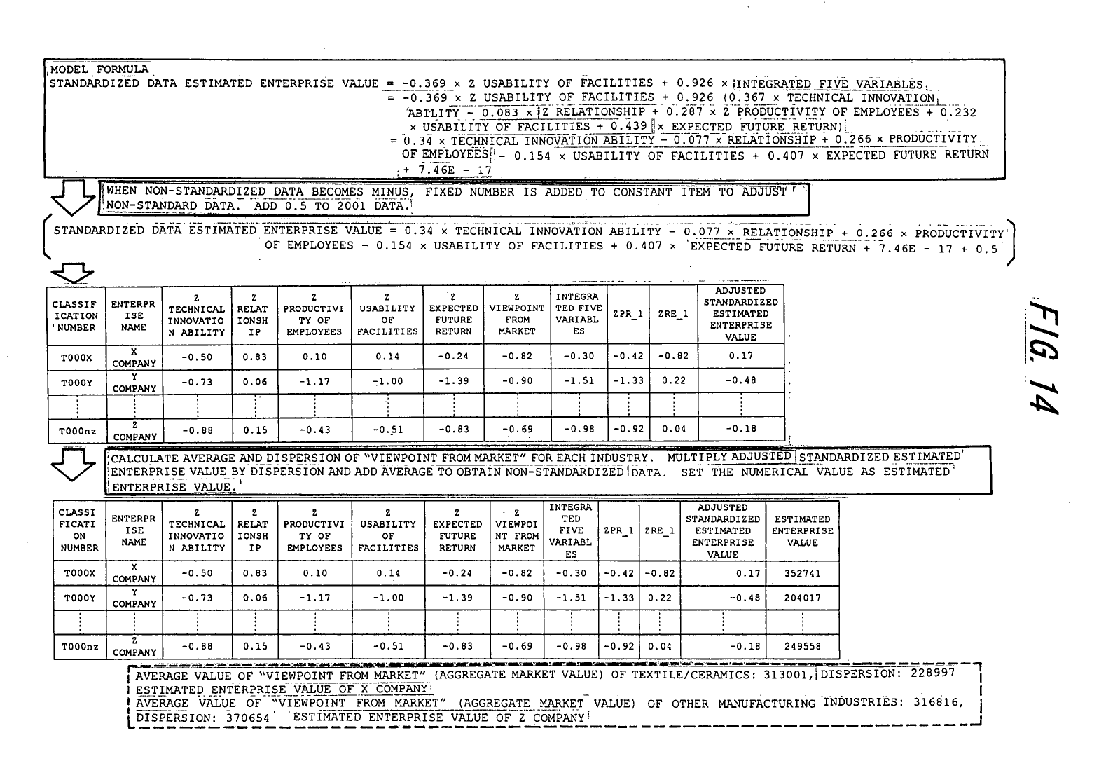

Note that, in the settlement of account in 2001, the five variables were integrated (weights of 0.367 for the technical innovation ability, −0.083 for the relationship, 0.287 for the productivity of employees, 0.232 for the usability of facilities, and 0.439 for the residual profit) and were subjected to the multiple regression analysis by the backward elimination method together with all the variables which are not integrated. A regression formula calculated as a result was as follows: explained variable (market point of view)=−0.36.9×usability of facilities+0.926 integrated variable. Respective significance levels were 0.000. This coefficient of the integrated variable was multiplied by the weights at the time of integration. As a result, weights for the respective explanatory variables in the multiple regression were 0.34 for the technical innovation ability, −0.077 for the relationship, 0.266 for the productivity of employees, −0.154 for the usability of facilities, and 0.407 for the expected future return (FIG. 14).

By comparison, weights obtained by a compulsory input method were 0.227, −0.004, 0.157, −0.057, and 0.571, respectively. It is seen from the weights calculated as a result of the calculation which factor has a problem in overall intellectual activities of an enterprise in the connection with an enterprise value under the present situation. It is made clear that the usability of facilities has a problem in the data of the settlement of account in 2001.

Subsequently, in order to return the standardized data to an actual amount, the standardized data is multiplied by standard deviation of aggregate market values of respective categories of business and added with average values. In an enterprise under severe price destruction, an actual amount becomes minus. In order to prevent the actual amount from becoming minus, a constant term of a linear function is translated to a range, in which the actual amount does not become minus, and adjusted. When the data of the settlement of an account in 2001 was used, the constant term, which is the result of the adjustment, was 7.455E−17+0.5. Thus, as shown in FIG. 14, the following expression was derived.
Estimated enterprise value=0.34×technical innovation ability−0.077×relationship+0.266×productivity of employees−0.154×usability of facilities+0.407×expected future return+7.455E−17+0.5

The standardized data after the adjustment was multiplied by the standard deviations of the aggregate market values of the respective categories of business and added with the average values to calculate estimated enterprise values.

Specifically, as shown in FIG. 14, an estimated enterprise value of X Company (T000X) was 352741 and an estimated enterprise value of Y Company (T000Y) was 204017.

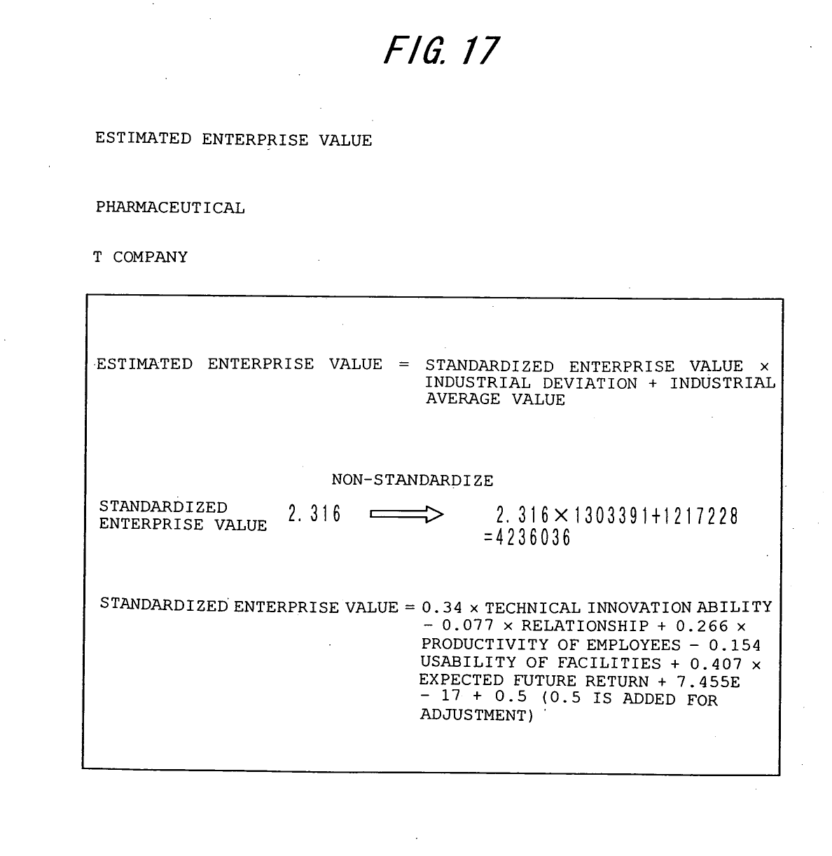

Note that FIG. 17 shows an example in which an estimated enterprise value was calculated for T Company as an example.

1. An intelligence value index calculation method for an enterprise, comprising:
calculating standardized data obtained by standardizing, for each of categories of business classified in advance, a technical innovation ability, relationship with customers and clients, productivity of employees, usability of facilities, an expected future return to be generated by intellectual activities, and a market viewpoint of each of enterprises stored in a database according to average values and standard deviations of the factors;
subjecting the standardized data to principal component analysis processing based on a variance covariance matrix collectively to calculate weights of the respective factors; and
calculating a numerical value, which is obtained by multiplying the respective factors by weights and adding up the factors for each of the enterprises, as intellectual potentialities.

2. An intelligence value index calculation method according to claim 1, wherein to the standardized data, a multiple regression analysis with an aggregate market value at the time of settlement of account set as an explained variable and data based on other evaluation factors set as explanatory factors is applied to calculate an estimated enterprise value.
